(19) United States
(12) Patent Application Publication
(10) Pub. No.: US 2005/0234822 A1
(43) Pub. Date: Oct. 20, 2005

(54) Methods and systems for universal transaction processing

(75) Inventors: Steven L. VanFleet, Southport, CT (US); John J. Mascavage III, San Mateo, CA (US); Matthew T. Byrne, Papillion, NE (US); Diane Wing, East Lansing, MI (US); Cassandra J. Mollett, Scottsdale, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/825,950

(22) Filed: Apr. 16, 2004

(51) Int. Cl. G06F 17/60; H04K 1/00; H04L 9/00

(52) U.S. Cl. 705/44; 705/42; 705/40

(57) ABSTRACT

In one embodiment, a first information packet is received at a payment network from a merchant, which includes a financial transaction cost and a credential presented by the customer as a payment for the financial transaction. The payment network uses the private label card account number to determine a financial account maintained by the customer at a financial institution and authorization information that allows debit access to the identified financial account; generates a second information packet comprising the transaction information, the account information, and the authorization information; and selects one of a plurality of transaction networks over which to transmit the second information packet to the financial institution. The second information is then transmitted from the payment network to the financial institution with a request to perform a debit transaction from the identified financial account for at least a portion of the cost of the financial transaction.

### CROSS-REFERENCES TO RELATED APPLICATIONS

This application is related to the following co-pending, commonly-assigned and concurrently filed U.S. patent applications, the entirety of each of which are herein incorporated by reference for all purposes: U.S. patent application Ser. No. ______, entitled “METHODS AND SYSTEMS FOR ONLINE TRANSACTION PROCESSING” (Attorney Docket No. 020375-050000); and U.S. patent application Ser. No. ______, entitled “METHODS AND SYSTEMS FOR PRIVATE LABEL TRANSACTION PROCESSING” (Attorney Docket No. 040143-050200).

### BACKGROUND OF THE INVENTION

This application relates generally to transaction processing. More specifically, this application relates to methods and systems for debit transaction processing.

Consumers may pay merchants for purchases using a variety of payment types. Typically, these payment types include cash, checks, and credit cards. Consumers may also elect to pay for purchases using a debit card. Debit cards are typically issued by the financial institution at which the consumer maintains a financial account and are used to debit the financial account for purchases or other services.

There are generally two types of debit cards. The first type of debit card is processed by an association, such as MASTERCARD. To the merchant, these types of cards are processed similar to a credit card, with similar high transaction costs incurred by the merchant. A second type of debit card may use a debit-based system to process the transaction. These debit cards are usually the same cards that a consumer may use to access an Automated Teller Machine (ATM). Typically, the consumer is required to enter a Personal Identification Number (PIN) at the time of the transaction to use the card. The second type of debit card usually results in a lower transaction cost to the merchant, but not all merchants accept these cards. Additionally, while lower than a credit-based transaction, the transaction costs are still higher than other networks, such as an automated clearing house (ACH) network used to transfer funds between financial institutions.

### BRIEF SUMMARY OF THE INVENTION

Methods and systems are disclosed for universal debit transaction processing. In one embodiment, a method is disclosed which comprises receiving, at a payment network, a first information packet from a merchant. The first information packet includes a cost of a financial transaction between the merchant and a customer. The first information packet also includes a credential presented by the customer as payment for the financial transaction. The payment network uses the credential to determine account information that identifies a financial account maintained by the customer at a financial institution and authorization information that allows debit access to the identified financial account. The payment network then generates a second information packet comprising the account information and the authorization information. The payment network selects one of a plurality of transaction networks over which to transmit the second information packet to the financial institution. The second information packet is then transmitted from the payment network to the financial institution using the selected transaction network, with a request to perform a debit transaction from the identified financial account for at least a portion of the cost of the financial transaction.

In some embodiments, the method may additionally comprise using the credential to determine, with the payment network, second account information and second authorization information. The second account information identifies a second financial account maintained by the customer at either the financial institution or a second financial institution, and the second authorization information is information that allows debit access to the identified second financial account. The payment network may also determine an apportionment of the cost among the first and second financial accounts and may generate a third information packet comprising the second account information, the second authorization information, and a portion of the cost to apply to the second financial account in accordance with the apportionment.

The method may also comprise receiving, at the payment network, a response from the financial institution. The response indicates approval or denial of the debit transaction. The payment network then transmit an authorization code to the merchant indicating approval or denial of the financial transaction in accordance with the response received from the financial institution. The payment network may also perform a risk analysis of the financial transaction and determine whether to provide a guarantee of the transaction to the merchant based on the risk analysis. The authorization code could also reflect whether the guarantee is provided.

Transmission of the second information packet to the financial institution may be accomplished in different ways. In one embodiment, the second information packet may be transmitted to the financial institution over an automated clearing house (“ACH”) network. In another embodiment, the second information packet may be transmitted to the financial institution over a debit system. In a third embodiment, the second information packet may be transmitted directly to the financial institution. The transaction network may be selected based on a risk analysis performed on the financial transaction.

The information comprised by the first information packet may vary according to the embodiment. For instance, in one embodiment, the credential may comprise a payment network account number assigned to the customer to access the payment network. In some embodiments, the credential may further comprise a personal identification number (PIN) and the method may additionally comprise verifying the PIN is associated with the payment network account. Additionally, in some embodiments, the financial transaction may be for an Internet-based financial transaction.

In a second embodiment, a method is disclosed which comprises receiving, at a payment network, an information packet from a merchant. The information packet includes a cost of a financial transaction between the merchant and a customer and a credential assigned to the customer. The credential is used to determine account information for a plurality of accounts identifying a plurality of financial accounts maintained by the customer at one or more financial institutions. The payment network uses the credential to determine authorization information for each of the identified financial accounts that allows access to the identified financial account. The payment network also determines an apportionment of the cost to apply to each of the identified financial accounts. The payment network then generates a plurality of authentication packets for each of the identified financial accounts. Each authentication packet comprises account information for one of the identified financial accounts, authorization information for the identified financial account, and the determined apportionment of the cost to apply to the identified financial account. The payment network transmits each of the authentication packets to the respective financial institution at which the financial account is maintained.

In one embodiment, a response may be received at the payment network indicating denial of the debit transaction. The payment network may then transmit an additional authentication packet including account information for a second one of the identified financial accounts different from the financial account associated with the denied authentication packet. The additional authentication packet also includes authorization information for the second financial account and the determined apportionment of the cost comprised by the denied authentication packet. Alternately, in a different embodiment, if a response is received at the payment network indicating denial of any of the authentication packets, an authorization code may be sent to the merchant indicating denial of the financial transaction. If all responses to the authentication packets indicate approval of the debit transaction, the authorization code may be sent to the merchant indicating approval of the financial transaction.

The apportionment of the cost to apply to each of the identified financial accounts may be performed in a variety of ways. For instance, the cost may be apportioned equally among the identified financial accounts. As a second example, the costs may be allocated using an allocation apportionment specified by the customer.

In a third embodiment, the method may comprise receiving, at a payment network, account information that identifies a plurality of financial accounts maintained by a customer at one or more financial institutions and authorization information for each of the identified financial accounts that allows debit access to the respective identified financial account. The payment network then verifies the account information and authorization information for each of the identified financial accounts. A credential is associated to the customer account information and the authorization information. The payment network transmits an enrollment approval for the customer.

The methods may be embodied in a payment network having a communications device, a processor, a storage device, and a memory coupled with the processor. The memory comprises a computer-readable medium having a computer-readable program embodied therein for directing operation of the payment network. The computer-readable program includes instructions for operating the computer system to manage information in accordance with the embodiments described above.

### BRIEF DESCRIPTION OF THE DRAWINGS

Illustrative embodiments in accordance with the invention are illustrated in the drawings in which:

FIG. 1 is a block diagram of a system that may be used for universal debit transaction processing;

FIG. 2 is a block diagram illustrating a payment network that may be used in the system of FIG. 1;

FIG. 3 is a block diagram of a computer system on which methods of the invention may be embodied;

FIG. 4 is a flow diagram illustrating an exemplary method for enrolling a customer into the payment network; and

FIG. 5 is a flow diagram illustrating an exemplary method for performing universal debit transaction processing.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

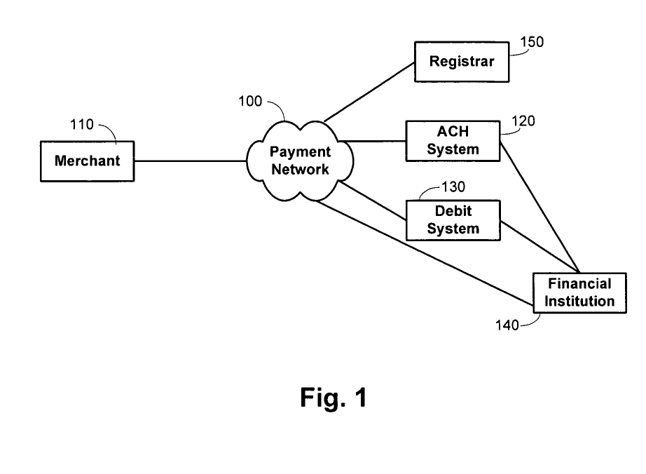

Methods and systems are provided for universal debit transaction processing. The debit transactions may be used to pay for a financial transaction between a merchant and a consumer. The financial transaction may involve the purchase of goods and/or services from the merchant. An overview of one system that may be used to support universal debit transaction processing is illustrated in FIG. 1.

The system includes a payment network 100, which may be interfaced to different types of systems that may be used in supporting debit transactions. For example, one such system is the automated clearing house (“ACH”) system 120, which is an electronic payment-delivery system known to those of skill in the art. The ACH system comprises a network that provides batch-oriented electronic funds transfer governed by the NACHA operating rules. Briefly, the ACH network provides ACH operators that act as an interface between originating and receiving depository financial institutions. Transactions received at a financial institution 140 during a day may be stored and processed later in batch mode to exploit economies of scale. Debit transactions may also be supported by a debit system 130, sometimes referred to in the art as a network that comprises “debit rails” for effecting communications between financial institutions 140 to execute debit transactions from demand deposit accounts (“DDAs”). The interconnection provided by such debit rails of the debit system 130 allows real-time access to a customer's DDA information, including account balance, so that real-time debits of the DDA may be made. For example, such debit rails may be provided by known networks such as the NYCE® network, the Pulse® network, the STAR® network, and the like. In still other instances, an intermediary system like the ACH system 120 or debit system 130 may be avoided by using a direct connection to a financial institution 140, providing so-called “direct-to-bank” interactions.

The payment network 100 may be directly connected to merchant 110 so that transaction information entered into between merchant 110 and customers may be communicated to the payment network 100 to support the transaction. By way of example, point-of-sale devices (not shown) at the merchant location may be communicatively coupled to the payment network 100. In alternate embodiments, merchant 110 may connect to the payment network through the Internet or other communication means. It should be appreciated that more than one merchant 110 location may be communicatively coupled to the payment network 100. Additional merchants 110 and financial institutions 140 may also be communicatively coupled to the payment network 100.

The security of information communicated between the payment network 100 and merchant 110 is generally greater with a direct connection. This is reflected by the illustration of FIG. 1 in which the payment network 100 is provided with interconnections to the ACH system 120, debit system 130, and direct links to financial institutions 140. As will be described in further detail below, the most sensitive financial information during transactions is communicated on this side of the system.

Parties may register with the payment network 100 using a registrar 150. Registrar 150 may be a separate entity as shown in FIG. 1 or may be merchant 110 or financial institution 140. In some embodiments, customers may be able directly register with the payment network 100.

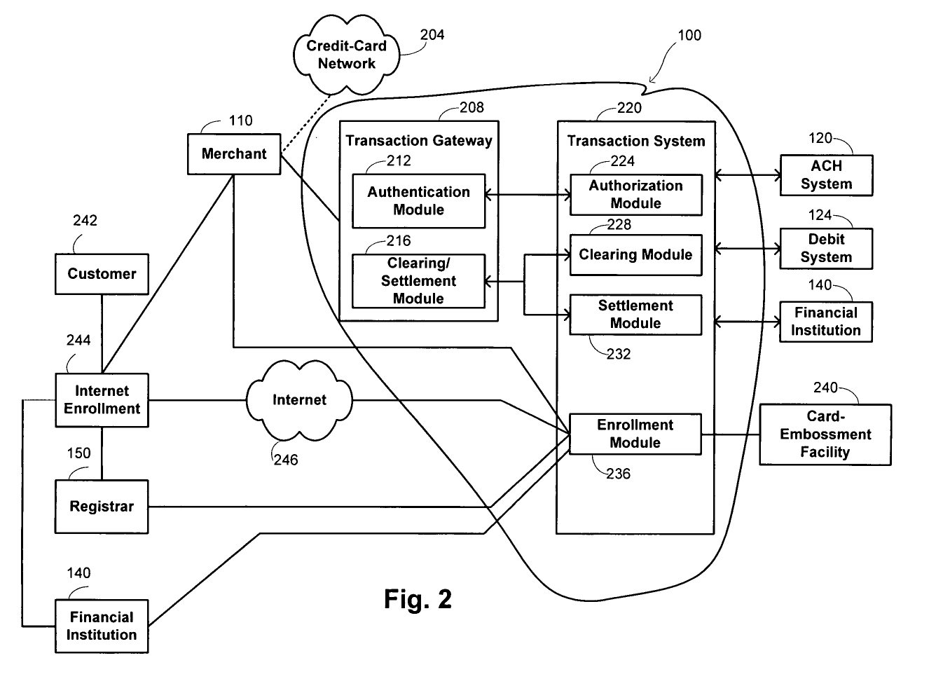

Details of the payment network 100 may be understood more fully with reference to FIG. 2, which shows an exemplary embodiment of the payment network 100. The payment network 100 may comprise a transaction gateway 208 and a transaction system 220, both of which may comprise a plurality of modules used in supporting transactions. The transaction gateway 208 may include an authentication module 212 that authenticates information provided by a merchant 110 during a transaction. The authentication module 212 interacts with an authorization module 224 of the transaction system 220 to coordinate seeking an authorization for the transaction. In addition, the transaction gateway 208 may further include a clearing/settlement module 216 that interacts with a clearing module 228 and a settlement module 232 of the transaction system 220 to perform clearing and settlement functions.

The transaction system 220 may also include an enrollment module 236 to accommodate different methods of enrollment. By way of example, customers may be enrolled by registrar 150, financial institution 140, or merchant 110. Customers may also request enrollment themselves by interacting directly with enrollment module 236 (e.g., using an Internet-based or other type of interface). The enrollment module 236 may also be in communication with a card-embossment facility 240 to accommodate those embodiments in which enrollment of a customer may be coupled with preparation of a magnetic-stripe or other type of card.

The structure shown in FIG. 2 emphasizes certain aspects of the arrangement that illustrate its flexibility and integration into existing financial infrastructures. For instance, in any given transaction between a merchant 110 and a customer, the customer may still have the option of executing the transaction with different mechanisms. Thus, while the solid lines between the merchants 110 and the transaction gateway 208 indicate paths that may be followed if the customer elects to perform a debit transaction using a credential assigned to the customer to access the payment network, the dashed lines indicate pathways to a credit-card network 204 that may be used if the customer elects to perform a credit transaction. The infrastructure illustrated in FIG. 2 may thus be integrated with existing infrastructures without compromising the performance of such existing infrastructures. The interconnection of the payment network 100 with existing ACH systems 120, debit systems 130, or financial institutions 140 are coordinated with the transaction system 220 in the illustrated embodiment, but may be coordinated by the transaction gateway 208 in certain other embodiments.

It should be appreciated that alternate embodiments of payment network 100 may not include all the components illustrated in FIG. 2 or may include different components. For instance, the functionality provided by transaction gateway 208 and transaction system 220 may be combined into one component. As another example, the modules of transaction gateway 208 and/or transaction system 220 may be combined or may be further separated into additional modules.

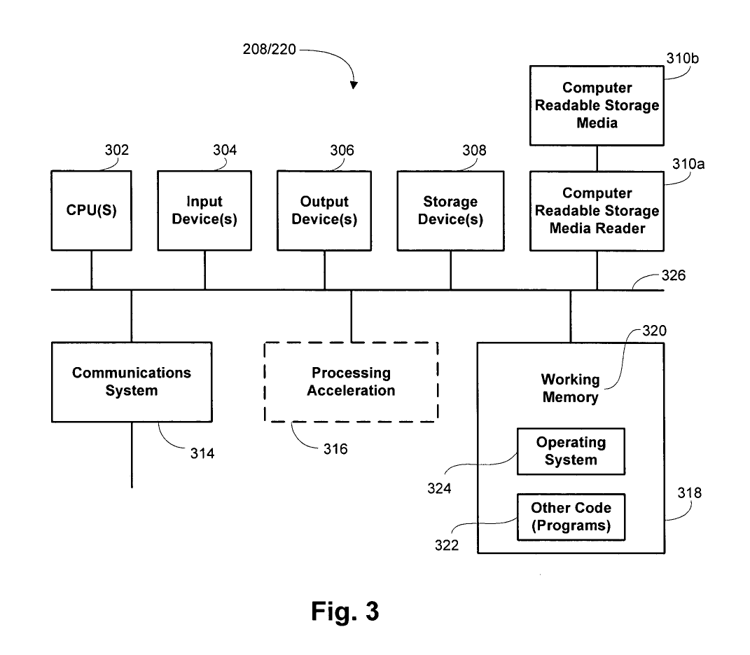

While FIG. 2 illustrates a logical structure for the payment system 100, FIG. 3 provides a schematic illustration of a physical structure that may be used to implement the transaction gateway 208 and/or transaction system 220 in one embodiment. FIG. 3 broadly illustrates how individual system elements may be implemented in a separated or more integrated manner. The structure 208/220 is shown comprised of hardware elements that are electrically coupled via bus 326, including a processor 302, an input device 304, an output device 306, a storage device 308, a computer-readable storage media reader 310a, a communications system 314, a processing acceleration unit 316 such as a DSP or special-purpose processor, and a memory 318. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the merchants 110, between the transaction gateway 208 and transaction system 220, with the ACH system 120, with the debit system 130, with the financial institution 140, with the card-embossment facility 240, or with any other external system as may be desired in implementing embodiments as described below.

The structure 208/220 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

The architecture described above may be used in a variety of embodiments to implement debit-based transactions. Use of the architecture may include enrollment functions, in which customers are assigned a private label card account number and/or credentials that may be used as a mechanism for identifying the customer and the account to be used in the private label card debit transactions. The private label card account number may be embossed on a magnetic-stripe card. The customer may additionally be assigned additional identifying credentials, such as a personal identification number (“PIN”). For security, the PIN may be assigned to the customer separately. Other credentials are also envisioned. Once the customer has been assigned a private label card account number and has enrolled in the payment network 100, he or she may engage in debit-based transactions using the private label card. As executed transactions accumulate, there may be periodic clearing and settlement functions performed to reconcile the transactions.

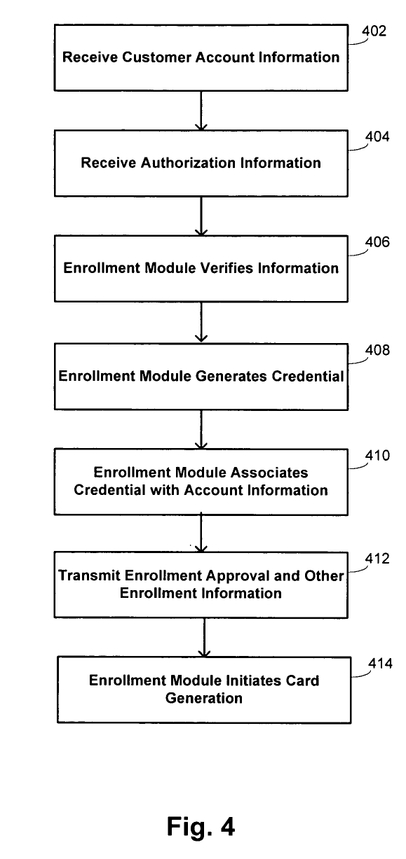

FIG. 4 is a flow diagram that illustrates an exemplary embodiment for enrolling a customer into the payment network 100. Enrollment module 236 receives 402 information identifying one or more customer accounts, such as demand deposit accounts (“DDAs”) from which funds are to be debited when the customer uses the private label card enrolled in the payment network 100. Such identification is typically made by the customer providing the primary account number (“PAN”) for the identified financial account(s) along with suitable financial-network routing information. The enrollment module 236 also receives 404 authorization information that allows debit access to the identified financial account(s). For example, the authorization information may comprise a personal identification number (“PIN”) assigned to the customer for accessing the identified financial account. In instances where more than one account is identified, a profile may be received or setup by the enrollment module 236 to identify allocations of debit transactions among the multiple accounts or specific identifications may be made at the time of a transaction.

The customer account information and authorization information may be provided to enrollment module 236 in a variety of different ways. In one embodiment, the information may be provided by a registrar 150 entering the information into a direct interface to enrollment module 236 or using an internet enrollment 244 interface. In another embodiment, the information may be received 402 from the financial institution 140 or merchant 110 using a direct interface to the enrollment module 236 or the internet enrollment 244 interface. In some embodiments, the customer may also enroll in the payment network directly using internet enrollment 244 interface. It should be appreciated that alternate interfaces may also be used to enroll the customer into the payment network 100.

Once the enrollment module 236 has collected the identification information, a verification 406 may be performed. Such verification may involve communications with the financial institution that maintains the identified account(s) to confirm the authenticity of the account information and authorization information (existence of the account, its ownership by the customer, correct authorization information, etc.). In some instances, the verification at block 406 may additionally include a risk-analysis based on such factors as the balance maintained in the identified account, credit score of the customer, demographic information regarding the customer, and the like. Approval of the customer to participate with the payment network 100 may depend in such instances not only on verification of the account status, but also on the customer having a satisfactory risk level.

If the customer information is accepted, the enrollment module 236 generates 408 a credential to be assigned to the customer to access the payment network 100. The credential may include an account number for the payment network. In some embodiments, the credential may also include a PIN associated with the payment network account number to provide additional security. In alternate embodiments, the credential or a portion of the credential (e.g., either or both of an account number and a PIN) may be provided to the enrollment module 236.

As described above, in some embodiments, the customer may provide more than one financial account from which funds are to be debited for future financial transactions entered into by the customer. In these embodiments, the enrollment module 236 may also be provided with an allocation apportionment for each of the financial accounts indicating the portion of future financial transactions to allocate to each of the identified financial accounts. Other types of instructions for allocating costs of future financial transactions may additionally or alternately be received. By way of example, accounts may be prioritized, and lower priority accounts may only be used if higher priority accounts are denied or otherwise unavailable for use.

The enrollment module associates 410 the credential with the account(so specified during enrollment. Additional information, such as instructions on how future financial transactions are to be allocated between accounts, may also be associated with the credential. The association of the credential with the account(s) specified by the user allows the payment network 100 to convert the credential to a form of information suitable for performing a debit transaction when the credential is used to pay for later financial transactions between the customer and the merchant 110. For example, the credential may be used to determine one or more PAN/PIN combinations used to ride the debit rails 130 or may be used to generate information suitable for one or more ACH transactions or one or more direct-to-bank transaction. The mapping between credentials and conventional debit-transaction identification information is maintained securely by the transaction gateway 208. Since this conventional information is not transmitted during transaction processing, there is little risk of it being compromised. In the event that the credential assigned to the customer is stolen, a different credential may be substituted without needing to change account information at the financial institutions where the account(s) are held.

Assuming the enrollment process was completed successfully, an enrollment approval may then be transmitted 412 to the user (e.g., registrar, customer, etc.) requesting enrollment. Additional information may also be transmitted to the user, such as credentials assigned to the customer. Some information may alternately or additionally be sent to the customer at a later time. For instance, a letter with a PIN number assigned to the customer may be mailed separately. The enrollment module 236 may also initiate a request to a card embossment facility 240 to generate 414 a new card magnetically encoded with the payment network account number (or other credential information). It should be appreciated that in some embodiments merchants may also need to be enrolled into the system in order to have the ability to accept the customer's credentials as payment for transactions.

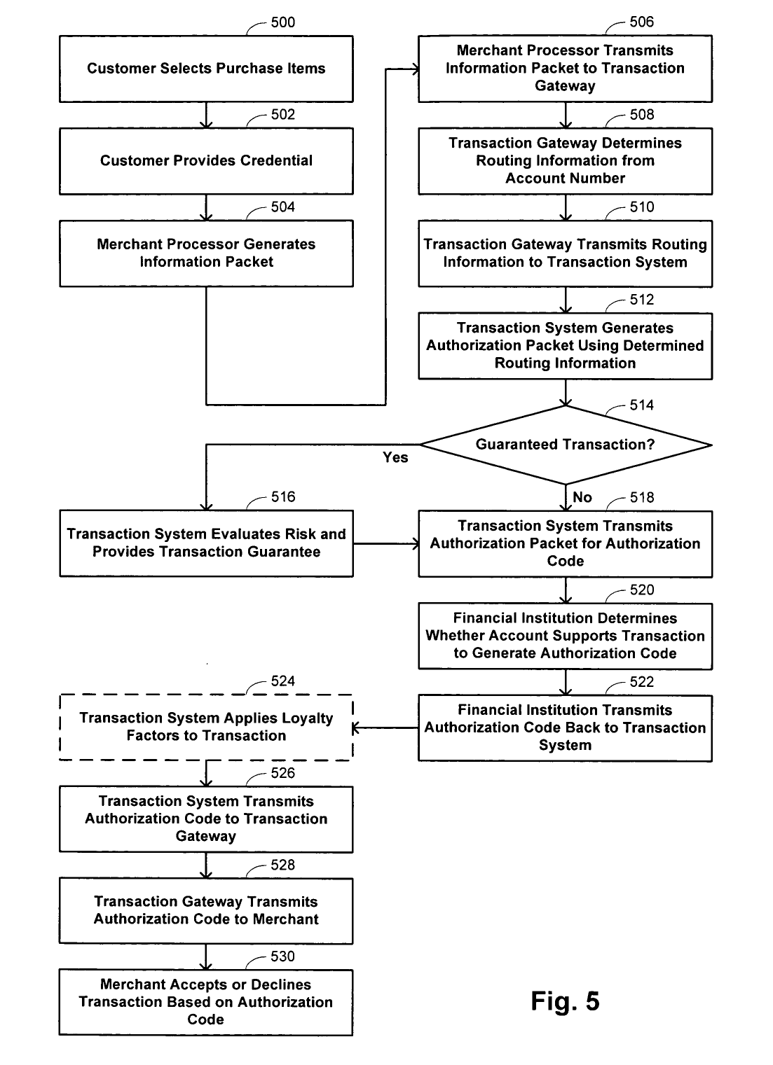

FIG. 5 is a flow diagram that provides an overview of methods used to execute a debit using the payment network 100 described above. A financial transaction between a merchant and a customer may be initiated by a customer selecting 500 a variety of purchase items or services. Purchase items may be selected 500 at a physical merchant site or a virtual site, such as an Internet site, provided by the merchant. After selecting the items, the customer then provides 502 a credential assigned to the customer to access the payment network 100 as payment for the items or services. In some cases, the credential may include a PIN associated with the customer's payment network account. The customer may enter the PIN into a point-of-sale (POS) device or otherwise provide the PIN to the merchant.

When the merchant has access both to details of the transaction, and the credential, the merchant generates 504 an information packet. By way of example, this information packet may be generated by a POS device located at the merchant site, a computer system hosting a merchant Internet site, or other type of merchant processor. The information packet usually includes at least a specification of the amount of the transaction, an identification of the merchant, and the credential. The information packet may also include additional information.

The information packet is then transmitted 506 from the merchant to the transaction gateway 208. If the credential includes a PIN, the transaction gateway may verify the PIN provided is associated with the customer payment network account. If the correct PIN is not provided, the transaction gateway may transmit a authorization code to the merchant indicating denial of the financial transaction and the method may end. Otherwise, if the correct PIN is provided (or a PIN is not required to access the payment network account), the transaction gateway 208 uses the credential comprised by the information packet to determine 508 routing information for the payment network account. The routing information may be for one or more financial accounts maintained by the customer at one or more financial institutions that are associated with the credential. In embodiments in which more than one financial account is associated with the credential, the transaction gateway 208 may also determine how the cost of the financial transaction is to be allocated between the financial accounts. As previously described, the transaction gateway 208 may access instructions provided by the customer or may use a default algorithm (e.g., apportioning the costs equally among the identified financial accounts) to determine how the cost is allocated.

The routing information is transmitted 510 to the transaction system 220 with the other information from the information packet like merchant identification and transaction amount for the identified financial account(s). The routing information is used by the authorization module 224 of the transaction system to generate 512 an authorization packet for each of the financial account(s). The authorization packet includes the financial account, associated authorization information, and the amount of the transaction to be applied to the financial account.

In some embodiments, the merchant may have the option of having the transaction guaranteed by the payment network 100. There are a number of different arrangements by which requests for guaranteed transactions may be initiated. For example, in some embodiments, all authorizations may be treated as guaranteed or all authorizations may be treated as non-guaranteed. In other embodiments, a merchant processor may pass an indicator with the information packet that specifies on a transaction-by-transaction basis whether the transaction is to be treated as guaranteed or non-guaranteed. In still other embodiments, rules may be established for implementation by the authorization module to define when to treat transactions as guaranteed or non-guaranteed. Such rules may account for such factors as the size of the transaction, the nature of the goods and/or services being sold, the identity of the customer, and the like.

A determination 514 is thus made in accordance with these different criteria whether a transaction is to be treated as a guaranteed transaction. If so, the transaction system 220 performs 516 a risk analysis of the transaction to determine whether to provide the guarantee. Such a risk analysis may take account of a variety of factors, such as the size of the transaction, the credit history of the customer, and the like, and may use standard techniques known to those of skill in the art in evaluating the risk. If the risk level associated with the transaction is acceptable, then the transaction is executed as a guaranteed transaction; if the risk level is determined to be unacceptably high, the transaction may be declined or an option may be fed back through the transaction gateway 208 to offer the merchant the possibility of treating the transaction as a non-guaranteed transaction. This provides a mechanism for overriding the predetermined factors defining when to treat a transaction as guaranteed, and offers the merchant an opportunity to determine whether to accept the transaction as a non-guaranteed transaction.

The transaction system 220 seeks an authorization code for the transaction from the financial institution(s) that holds the account(s) to be debited. Seeking such an authorization code begins by transmitting 518 the authorization packet(s) that was generated 512 to the financial institution 140 associated with the financial account. Such transmittal may take place through any suitable debit-transaction mechanism, including the ACH system 120, the debit system 124, or a direct-to-bank connection to the financial institution 140 associated with the account.

In one embodiment, the transaction system 220 may select from a plurality of possible transaction networks that may be used to perform the debit transaction. By way of example, the transaction networks from which the transaction system 220 may select may include the ACH system 120, the debit system 130, or direct-to-bank connection. The processor may set up logical rules to determine which transaction network to select. For instance, the transaction network may be selected based on a risk analysis of the financial transaction performed by the processor. Higher risk transactions may be processed on a transaction network with higher transaction costs but with little or no risk that funds will be available to cover the costs. Similarly, lower risk transactions may be processed on a transaction network with lower transaction costs but having a higher risk that funds may not be available to cover the costs. By way of example, higher risk transactions may use the debit system 130, while lower transactions may use the ACH system 120. Other criteria, such as whether the merchant 110 requests a guarantee 514, may also be used to select the transaction network.

For each of the financial accounts for which an authorization packet was generated, the respective financial institution 140 at which the account is maintained determines 520 whether the account identified by the authorization packet has sufficient cleared funds to support the transaction and transmits 522 an authorization code back to the transaction system 220 to reflect its determination. If the account has sufficient cleared funds and there are no other derogatory marks associated with the account, the authorization code comprises an approval of the transaction, while a failure to meet those conditions results in the authorization code comprising a denial of the transaction.

The transaction system 220 may, in some embodiments, be equipped to perform additional operations related to the transaction. Merely by way of example, FIG. 5 note that in some embodiments, loyalty factors may be applied 524 to the transaction. Such loyalty factors typically require monitoring an accumulated transaction amount associated with an individual customer, perhaps based on certain defined classifications of transactions, so that rewards may be provided to the customer when certain accumulation levels are met. Such rewards may take the form of points that may be redeemed to purchase items from the merchant, for air travel or other products, or may take the form of cash rewards that are deposited directly to the customers identified account, and the like. Still other types of operations additional to coordination of the debit transaction will be known to those of skill in the art and may be applied to transactions in other embodiments. In other embodiments, additional operations may not be performed.

The transaction system 220 transmits 526 the received authorization code(s) to the transaction gateway 208. In embodiments in which an authorization packet was generated 512 for only one financial account, the transaction gateway may then transmit 528 the authorization code to the merchant 110 in accordance with the authorization code received from the financial institution 140. In embodiments in which more than one financial account is used to pay for the financial transaction, the transaction gateway 208 may transmit 528 an authorization code to the merchant indicting approval of the transaction if all authorization code(s) received in response to the authorization packets indicated approval. Otherwise, if one or more authorization code(s) received by the transaction gateway 208 indicate denial of the transaction, the transaction gateway 208 may transmit 528 an authorization code to the merchant indicating denial of the transaction. The merchant makes a determination 530 whether to accept or decline the transaction based on the authorization code, usually acting in strict accordance with the recommended acceptance or rejection of the transaction transmitted 528 by the transaction gateway.

In an alternate embodiment, if a denial to one or more authorization code(s) received from a financial institution 140 indicates denial of the debit transaction, the transaction gateway 208 may attempt to debit the amount from an alternate account. Thus, the transaction gateway 208 may determine 508 routing information for a second financial account different than the denied account from which the apportionment of the cost allocated to the denied account may be debited. The then continue with 510 until an authorization code is received 522 for the second financial account. The second financial account may be determined by instructions associated with the customer credential or other default algorithm. If denial to the second account is received 522, the transaction gateway 208 may attempt to initiate a debit transaction for the denied amount from a different account associated with the credential or may transmit 528 an authorization code indicating denial of the transaction.

In some instances, because the way the transaction information is routed as described above, the returned code may be converted from one form to another by the transaction system 220 or transaction gateway 208. In particular, such conversion is typically performed so that the merchant 110 may make its decision whether to accept or decline the transaction based on the type of code response expected without substantial modification of its system. For example, in an embodiment where the merchant is equipped to receive credit-based authorization codes and transmits the authentication packet in a form that requests execution of a guaranteed transaction, the code returned to the transaction gateway 208 may take the form of a debit-based authorization code. In such an embodiment, the transaction gateway 208 may convert the debit-based code to a corresponding credit-based code that is easily understood by existing merchant systems.

In some embodiments, reporting capabilities may be provided to the customers. These reports may allow a customer to view previous transactions for the customer that were paid for using the customer's credentials. Alternately or additionally, reports may also be provided to merchants to allow the merchant to view merchant transactions that used payment network 100.

In the foregoing description, for the purposes of illustration, methods were described in a particular order. It should be appreciated that in alternate embodiments, the methods may be performed in a different order than that described. It should also be appreciated that various modifications, alternative constructions, and equivalents may be used without departing from the spirit of the invention. Accordingly, the above description should not be taken as limiting the scope of the invention, which is defined in the following claims.

1. A computerized method comprising:
receiving, at a payment network, a first information packet from a merchant, the first information packet including a cost of a financial transaction between the merchant and a customer and a credential presented by the customer as a payment for the financial transaction;
using the credential to determine, with the payment network, account information that identifies a financial account maintained by the customer at a financial institution and authorization information that allows debit access to the identified financial account;
generating, at the payment network, a second information packet comprising the account information and the authorization information;
selecting one of a plurality of transaction networks over which to transmit the second information packet to the financial institution;
transmitting from the payment network the second information packet to the financial institution using the selected transaction network, with a request to perform a debit transaction from the identified financial account for at least a portion of the cost of the financial transaction.

2. The method of claim 1, further comprising using the credential to determine, with the payment network, second account information that identifies a second financial account maintained by the customer at one of the financial institution and a second financial institution and second authorization information that allows debit access to the identified second financial account.

3. The method of claim 2, further comprising:
determining, at the payment network, an apportionment of the cost among the first and second financial accounts;
generating, at the payment network, a third information packet comprising the second account information, the second authorization information, and a portion of the cost to apply to the second financial account in accordance with the apportionment; and
wherein the second information packet further includes a second portion of the cost to apply to the financial account in accordance with the apportionment.

4. The method of claim 1, further comprising:
receiving, at the payment network, a response from the financial institution indicating approval or denial of the debit transaction; and
transmitting, from the payment network, an authorization code to the merchant indicating approval or denial of the financial transaction in accordance with the response received from the financial institution.

5. The method of claim 4, further comprising:
performing, with the payment network, a risk analysis of the financial transaction; and
determining, with the payment network, whether to provide a guarantee of the financial transaction to the merchant based on the risk analysis,
wherein the authorization code further reflects whether the guarantee is provided.

6. The method of claim 1, wherein:
the account information comprises a primary account number for the identified financial account; and
the authorization information comprises a personal identification number assigned to the customer for accessing the identified financial account.

7. The method of claim 1, wherein selecting one of a plurality of transaction networks comprises:
performing, with the payment network, a risk analysis of the financial transaction; and
selecting the transaction network based on the risk analysis.

8. The method of claim 1, wherein selecting one of a plurality of transaction networks comprises selecting an automated clearing house (“ACH”) network.

9. The method of claim 1, wherein selecting one of a plurality of transaction networks comprises selecting a debit system.

10. The method of claim 1, wherein selecting one of a plurality of transaction networks comprises selecting a direct network path to the financial institution from the payment network.

11. The method of claim 1, wherein the credential comprises a payment network account number assigned to the customer to access the payment network.

12. The method of claim 11:
wherein the credential further comprises a personal identification number (PIN); and
wherein the method further comprises verifying, with the payment network, the PIN is associated with the payment network account.

13. The method of claim 1, further comprising crediting, with the payment network, a loyalty program for the customer in response to execution of the financial transaction.

14. The method of claim 1, wherein receiving the first information packet comprises receiving the first information packet from an Internet merchant and wherein the financial transaction is an Internet-based financial transaction.

15. A computerized method comprising:
receiving, at a payment network, a first information packet from a merchant, the first information packet including a cost of a financial transaction between the merchant and a customer and a credential presented by the customer as a payment for the financial transaction;
using the credential to determine, with the payment network, account information that identifies a financial account maintained by the customer at a financial institution and authorization information that allows debit access to the identified financial account;
generating, at the payment network, a second information packet comprising the account information and the authorization information;
transmitting from the payment network the second information packet to the financial institution using an automated clearing house (ACH) network, with a request to perform a debit transaction from the identified financial account for the cost of the financial transaction.

16. A computerized method comprising:
receiving, at a payment network, an information packet from a merchant, the information packet including a cost of a financial transaction between the merchant and a customer and a credential assigned to the customer;
using the credential to determine, with the payment network, account information identifying a plurality of financial accounts maintained by the customer at one or more financial institutions;
using the credential to determine, with the payment network, authorization information for each of the identified financial accounts that allows access to the identified financial accounts;
determining, at the payment network, an apportionment of the cost to apply to each of the identified financial accounts;
generating, at the payment network, a plurality of authentication packets for each of the identified financial accounts, each authentication packet comprising account information for one of the identified financial accounts, authorization information for the identified financial account, and the determined apportionment of the cost to apply to the identified financial account; and
transmitting from the payment network, each of the authentication packets to the respective financial institution at which the financial account is maintained.

17. The method of claim 16, further comprising receiving, at the payment network, a response to one of the authentication packets indicating denial of the debit transaction; and
transmitting an additional authentication packet comprising account information for a second one of the identified financial accounts different from the financial account associated with the denied authentication packet, authorization information for the second financial account, and the determined apportionment of the cost comprised by the denied authentication packet.

18. The method of claim 17, further comprising:
receiving a response to the additional authentication packet indicating denial of the debit transaction; and
transmitting, from the payment network, an authorization code to the merchant indicating denial of the financial transaction.

19. The method of claim 16, further comprising:
receiving, at the payment network, a response to each of the authentication packets indicating approval or denial of the debit transaction;
transmitting, from the payment network, an authorization code to the merchant indicating approval or denial of the financial transaction, wherein the authorization code indicates denial of the financial transaction if at least one of the authentication packets indicates a denial of the debit transaction.

20. The method of claim 16, wherein determining an apportionment of the cost comprises apportioning the cost equally among the identified financial accounts.

21. The method of claim 16, wherein determining an apportionment of the cost comprises using an allocation apportionment specified by the customer.

22. A method comprising:
receiving, at a payment network, account information that identifies a plurality of financial accounts maintained by a customer at one or more financial institutions and authorization information for each of the identified financial accounts that allows debit access to the respective identified financial account;
verifying, with the payment network, the account information and authorization information for each of the identified financial accounts;
associating a credential to the customer account information and the authorization information; and
transmitting, from the payment network, an enrollment approval for the customer.

23. The method of claim 22, wherein verifying the account information and the authorization information comprises for each of the identified financial accounts:
transmitting, from the payment network, the account information and the authorization information to the financial institution associated with the identified financial account with a request to authenticate the information for the identified financial account;
receiving, at the payment network, a response from the financial institution authenticating the information.

24. The method of claim 22, further comprising receiving, at the payment network, an allocation apportionment for each of the identified financial accounts indicating the portion of future financial transactions to allocate to each of the identified financial accounts.

25. The method of claim 22, wherein associating the card number comprises generating, with the payment network, a unique account number for the customer to access the payment network.

26. The method of claim 22, further comprising transmitting a request from the payment network to a card embossing facility to magnetically encode the unique account number on a card.

27. A payment network comprising:
a communications device;
a processor;
a storage device; and
a memory coupled with the processor, the memory comprising a computer-readable medium having a computer-readable program embodied therein for directing operation of the payment network, the computer-readable program including:
instructions for receiving, with the communications device, a first information packet from a merchant, the first information packet including a cost of a financial transaction between the merchant and a customer and a credential presented by the customer as a payment for the financial transaction;
instructions for determining from the credential, with the processor, account information that identifies a financial account maintained by the customer at a financial institution and authorization information that allows debit access to the identified financial account;
instructions for generating, with the processor, a second information packet comprising the transaction information, the account information, and the authorization information;
instructions for selecting, with the processor, one of a plurality of transaction networks over which to transmit the second information packet to the financial institution; and
instructions for transmitting, with the communications device, the second information packet to the financial institution using the selected transaction network, with a request to perform a debit transaction from the identified financial account for at least a portion of the cost of the financial transaction.

28. The payment network of claim 27 wherein the computer-readable program further includes instructions for determining from the credential, with the processor, second account information that identifies a second financial account maintained by the customer at one of the financial institution and a second financial institution, and second authorization information that allows debit access to the identified second financial account.

29. The payment network of claim 28, wherein the computer-readable program further includes:
instructions for determining, with the processor, an apportionment of the cost among the first and second financial accounts;
instructions for generating, with the processor, a third information packet comprising the second account information, the second authorization information, and a portion of the cost to apply to the second financial account in accordance with the apportionment; and
wherein the second information packet further includes a second portion of the cost to apply to the financial account in accordance with the apportionment.

30. The payment network of claim 27, wherein the computer-readable program further includes:
instructions for receiving, with the communications device, a response from the financial institution indicating approval or denial of the debit transaction; and
instructions for transmitting, with the communications device, an authorization code to the merchant indicating approval or denial of the financial transaction in accordance with the response received from the financial institution.

31. The payment network of claim 28 wherein the computer-readable program further includes:
instructions for performing, with the processor, a risk analysis of the financial transaction; and
instructions for determining, with the processor, whether to provide a guarantee of the financial transaction to the merchant based on the risk analysis,
wherein the authorization code further reflects whether the guarantee is provided.

32. The payment network of claim 27, wherein the instructions for selecting one of a plurality of transaction networks comprise:
instructions for performing, with the processor, a risk analysis of the financial transaction; and
instructions for selecting, with the processor, the transaction network based on the risk analysis.

33. The payment network of claim 27, wherein:
the communications system is coupled with an automated clearing house (“ACH”) network; and
the instructions for selecting one of a plurality of transaction networks comprise instructions for selecting the ACH network.

34. The payment network of claim 27, wherein the instructions for selecting one of a plurality of transaction networks comprise instructions for selecting a debit system.

35. The payment network of claim 27, wherein the instructions for selecting one of a plurality of transaction networks comprise instructions for selecting a direct network path to the financial institution from the payment network.

36. The payment network of claim 27, wherein:
the account information comprises a primary account number (“PAN”) for the identified financial account; and
the authorization information comprises a personal identification number (“PIN”) assigned to the customer for accessing the identified financial account.

37. The payment network of claim 27, wherein the credential comprises a payment network account number assigned to the customer to access the payment network and a personal identification number (PIN) and wherein the computer-readable program further comprises instructions for verifying, with the processor, the PIN is associated with the payment network account.

38. The payment network of claim 27, wherein the computer-readable program further comprises instructions for crediting, with the processor, a loyalty program for the customer in response to execution of the financial transaction.

39. A payment network comprising:.
a communications device;
a processor;
a storage device; and
a memory coupled with the processor, the memory comprising a computer-readable medium having a computer-readable program embodied therein for directing operation of the payment network, the computer-readable program including:
instructions for receiving, account information that identifies a plurality of financial accounts maintained by a customer at one or more financial institutions and authorization information for each of the identified financial accounts that allows debit access to the respective identified financial account;
instructions for verifying, with the processor, the account information and authorization information for each of the identified financial accounts;
instructions for associating, with the processor, a credential to the customer account information and the authorization information; and
instructions for transmitting, with the communications device, an enrollment approval for the customer.

40. The payment network of claim 39, wherein the instructions for verifying the account information and the authorization information comprise instructions for each of the identified financial accounts:
instructions for transmitting, with the communications device, the account information and the authorization information to the financial institution associated with the identified financial account with a request to authenticate the information for the identified financial account;
instructions for receiving, with the communications device, a response from the financial institution authenticating the information.

41. The payment network of claim 39, wherein the computer-readable program further comprises:
instructions for receiving, with the communications device, an allocation apportionment for each of the identified financial accounts indicating the portion of future financial transactions to allocate to each of the identified financial accounts.

42. The payment network of claim 39, wherein the computer-readable program further includes instructions for generating, with the processor, a unique account number for the customer to access the payment network.
